(19) United States
(12) Patent Application Publication
(10) Pub. No.: US 2025/0211358 A1
(43) Pub. Date: Jun. 26, 2025

(54) OPTICAL COMMUNICATION SYSTEM, OPTICAL SIGNAL CONTROL METHOD, AND OPTICAL COMMUNICATION APPARATUS

(71) Applicant: NEC Corporation, Tokyo (JP)

(72) Inventor: Kenji MORIMOTO, Tokyo (JP)

(73) Assignee: NEC Corporation, Tokyo (JP)

(21) Appl. No.: 18/969,403

(22) Filed: Dec. 5, 2024

(30) Foreign Application Priority Data
Dec. 26, 2023 (JP) 2023-219928

(51) Int. Cl. H04J 14/02; H04B 10/079

(52) U.S. Cl. CPC H04J 14/0221; H04B 10/0795

(57) ABSTRACT

A control apparatus performs: span loss adjustment processing of adjusting a span loss of a first optical signal based on first and third intensities, and adjusting a span loss of a second optical signal based on second and fourth intensities by controlling an optical signal adjustment unit; and intensity difference adjustment processing of adjusting the intensity difference between the first and second optical signals after a span loss adjustment in a second optical communication apparatus by controlling first and second intensity adjustment units. The control apparatus performs the span loss adjustment processing and the intensity difference adjustment processing as an initial setting operation after output of a third optical signal from a first optical communication apparatus starts and performs a monitoring operation of repeating the span loss adjustment processing and the intensity difference adjustment processing on a predetermined cycle after the initial setting operation ends.

### INCORPORATION BY REFERENCE

This application is based upon and claims the benefit of priority from Japanese patent application No. 2023-219928, filed on Dec. 26, 2023, the disclosure of which is incorporated herein in its entirety by reference.

### TECHNICAL FIELD

The present disclosure relates to an optical communication system, an optical signal control method, and an optical communication apparatus.

### BACKGROUND ART

A wavelength division multiplexed (WDM) optical signal acquired by multiplexing optical signals at different wavelengths may be used in an optical communication system. At this time, control of the intensity difference between signals at different wavelengths at the time of reception and/or compensation of a loss in a transmission channel may be performed to acquire desired signal quality at the time of reception.

For example, Japanese Unexamined Patent Application Publication No. H8-321824 proposes a wavelength division multiplexing communication method for decreasing the difference between optical-signal-to-noise ratios at wavelengths in a WDM optical signal at the receiving end by controlling an amount of pre-emphasis of optical signals at the transmitting end.

### SUMMARY

However, a so-called span loss and an optical signal are generated in transmission of a WDM optical signal. Further, a variation caused by the difference between wavelengths in a WDM optical signal occurs in the losses of optical signals at the wavelengths after transmission over an optical transmission line. Therefore, control for bringing the intensity of an optical signal at each wavelength after transmission over the optical transmission line into a certain range is required. However, an adjustment of the intensity of an optical signal at each wavelength after transmission over an optical transmission line generally requires complicated adjustment work, such as manually adjusting the intensity of the optical signal at the time of transmission and the gain of an amplifier provided on a transmission channel while checking signal quality at the time of reception.

In a first example aspect of the present disclosure, an optical communication system includes: a first optical communication apparatus configured to output a third optical signal acquired by wavelength division multiplexing a first optical signal at a first wavelength and a second optical signal at a second wavelength different from the first wavelength; a second optical communication apparatus configured to be able to amplify the third optical signal input from the first optical communication apparatus through an optical transmission line; an optical signal adjustment unit configured to be able to adjust an intensity of each of the first and second optical signals wavelength division multiplexed in the third optical signal in the second optical communication apparatus; and a control apparatus configured to control the first optical communication apparatus and the optical signal adjustment unit, wherein the first optical communication apparatus includes: a first intensity adjustment unit configured to adjust an intensity of the first optical signal; a second intensity adjustment unit configured to adjust an intensity of the second optical signal; a multiplexing unit configured to output the third optical signal acquired by wavelength division multiplexing the first optical signal and the second optical signal to the optical transmission line; and a first intensity monitoring unit configured to monitor a first intensity being an intensity of the first optical signal input to the multiplexing unit and a second intensity being an intensity of the second optical signal input to the multiplexing unit, the second optical communication apparatus includes a second intensity monitoring unit configured to monitor a third intensity being an intensity of the first optical signal wavelength division multiplexed in the third optical signal and a fourth intensity being an intensity of the second optical signal wavelength division multiplexed in the third optical signal in the second optical communication apparatus, and the control apparatus can perform: span loss adjustment processing of adjusting a span loss of the first optical signal by controlling the optical signal adjustment unit, based on the first intensity and the third intensity, and adjusting a span loss of the second optical signal by controlling the optical signal adjustment unit, based on the second intensity and the fourth intensity; and intensity difference adjustment processing of adjusting an intensity difference between the first optical signal and the second optical signal after a span loss adjustment in the second optical communication apparatus by controlling at least one of the first and second intensity adjustment units, performs the span loss adjustment processing and the intensity difference adjustment processing as an initial setting operation after output of the third optical signal from the first optical communication apparatus starts, and performs a monitoring operation of repeating the span loss adjustment processing and the intensity difference adjustment processing on a predetermined cycle after the initial setting operation ends.

In a second example aspect of the present disclosure, an optical signal control method includes, in an optical communication system including: a first optical communication apparatus configured to output a third optical signal acquired by wavelength division multiplexing a first optical signal at a first wavelength and a second optical signal at a second wavelength different from the first wavelength; a second optical communication apparatus configured to be able to amplify the third optical signal input from the first optical communication apparatus through an optical transmission line; and an optical signal adjustment unit configured to be able to adjust an intensity of each of the first and second optical signals wavelength division multiplexed in the third optical signal in the second optical communication apparatus, wherein the first optical communication apparatus includes: a first intensity adjustment unit configured to adjust an intensity of the first optical signal; a second intensity adjustment unit configured to adjust an intensity of the second optical signal; a multiplexing unit configured to output the third optical signal acquired by wavelength division multiplexing the first optical signal and the second optical signal to the optical transmission line; and a first intensity monitoring unit configured to monitor a first intensity being an intensity of the first optical signal input to the multiplexing unit and a second intensity being an intensity of the second optical signal input to the multiplexing unit, and the second optical communication apparatus includes a second intensity monitoring unit configured to monitor a third intensity being an intensity of the first optical signal wavelength division multiplexed in the third optical signal and a fourth intensity being an intensity of the second optical signal wavelength division multiplexed in the third optical signal in the second optical communication apparatus: performing: span loss adjustment processing of adjusting a span loss of the first optical signal by controlling the optical signal adjustment unit, based on the first intensity and the third intensity, and adjusting a span loss of the second optical signal by controlling the optical signal adjustment unit, based on the second intensity and the fourth intensity; and intensity difference adjustment processing of adjusting an intensity difference between the first optical signal and the second optical signal after a span loss adjustment in the second optical communication apparatus by controlling at least one of the first and second intensity adjustment units; performing the span loss adjustment processing and the intensity difference adjustment processing as an initial setting operation after output of the third optical signal from the first optical communication apparatus starts; and performing a monitoring operation of repeating the span loss adjustment processing and the intensity difference adjustment processing on a predetermined cycle after the initial setting operation ends.

In a third example aspect of the present disclosure, an optical communication apparatus includes: a first light input unit configured to be able to amplify a first wavelength division multiplexed optical signal being acquired by wavelength division multiplexing a first optical signal at a first wavelength and a second optical signal at a second wavelength different from the first wavelength and being input from a second light output unit through a first optical transmission line; a wavelength division demultiplexing unit configured to wavelength division demultiplex the first wavelength division multiplexed optical signal into the first optical signal and the second optical signal; and a first light output unit configured to output a second wavelength division multiplexed optical signal acquired by wavelength division multiplexing the first optical signal and the second optical signal that are wavelength division demultiplexed by the wavelength division demultiplexing unit to a second light input unit through a second optical transmission line, wherein a first optical signal adjustment unit can adjust an intensity of each of the first and second optical signals wavelength division multiplexed in the first wavelength division multiplexed optical signal in the first light input unit, a second optical signal adjustment unit can adjust an intensity of each of the first and second optical signals wavelength division multiplexed in the second wavelength division multiplexed optical signal in the second light input unit, a control apparatus controls the first and second light output units and the first and second optical signal adjustment units, each of the first and second light output unit includes: a first intensity adjustment unit configured to adjust an intensity of the first optical signal; a second intensity adjustment unit configured to adjust an intensity of the second optical signal; a multiplexing unit configured to output a wavelength division multiplexed optical signal acquired by wavelength division multiplexing the first optical signal and the second optical signal; and a first intensity monitoring unit configured to monitor a first intensity being an intensity of the first optical signal input to the multiplexing unit and a second intensity being an intensity of the second optical signal input to the multiplexing unit, each of the first and second light input unit includes a second intensity monitoring unit configured to monitor, inside each unit, a third intensity being an intensity of the first optical signal wavelength division multiplexed in an input wavelength division multiplexed optical signal and a fourth intensity being an intensity of the second optical signal wavelength division multiplexed in the input wavelength division multiplexed optical signal, between the first light output unit and the first light input unit, the control apparatus can perform: span loss adjustment processing of adjusting a span loss of the first optical signal by controlling the first optical signal adjustment unit, based on the first intensity and the third intensity, and adjusting a span loss of the second optical signal by controlling the first optical signal adjustment unit, based on the second intensity and the fourth intensity; and intensity difference adjustment processing of adjusting an intensity difference between the first optical signal and the second optical signal after a span loss adjustment in the first light input unit by controlling at least one of the first and second intensity adjustment units, performs the span loss adjustment processing and the intensity difference adjustment processing as an initial setting operation after output of the first wavelength division multiplexed optical signal from the first light output unit starts, and performs a monitoring operation of repeating the span loss adjustment processing and the intensity difference adjustment processing on a predetermined cycle after the initial setting operation ends, and, between the second light output unit and the second light input unit, the control apparatus further can perform: span loss adjustment processing of adjusting a span loss of the first optical signal by controlling the second optical signal adjustment unit, based on the first intensity and the third intensity, and adjusting a span loss of the second optical signal by controlling the second optical signal adjustment unit, based on the second intensity and the fourth intensity; and intensity difference adjustment processing of adjusting an intensity difference between the first optical signal and the second optical signal after a span loss adjustment in the second light input unit by controlling at least one of the first and second intensity adjustment units, performs the span loss adjustment processing and the intensity difference adjustment processing as an initial setting operation after output of the second wavelength division multiplexed optical signal from the second light output unit starts, and performs a monitoring operation of repeating the span loss adjustment processing and the intensity difference adjustment processing on a predetermined cycle after the initial setting operation ends.

An example advantage according to the above-described embodiments is that a span loss adjustment of an optical signal at each wavelength in a wavelength division multiplexed optical signal and an adjustment of the intensity difference between optical signals can be automatically and efficiently performed.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram schematically illustrating a basic configuration of an optical communication system according to an example embodiment;

FIG. 2 is a diagram illustrating a configuration example of an optical signal output unit according to the example embodiment;

FIG. 3 is a diagram illustrating a configuration example of an optical amplification unit according to the example embodiment;

FIG. 4 is a flowchart of an optical signal adjustment operation in the optical communication system according to the example embodiment;

FIG. 5 is a state transition diagram in the optical signal adjustment operation in the optical communication system according to the example embodiment;

FIG. 6 is a block diagram schematically illustrating a configuration of an optical communication system according to an example embodiment; and

FIG. 7 is a block diagram schematically illustrating a configuration of an optical communication apparatus according to the example embodiment.

### EXAMPLE EMBODIMENT

Example embodiments according to the present disclosure will be described below with reference to the drawings. In each drawing, the same components are given the same sign, and repeated description thereof is omitted as needed.

Reference to an example embodiment in the following description means that the example embodiment is applicable to one of example embodiments described below or a combination of two or more example embodiments and also means that application is not limited to a specific example embodiment.

### First Example Embodiment

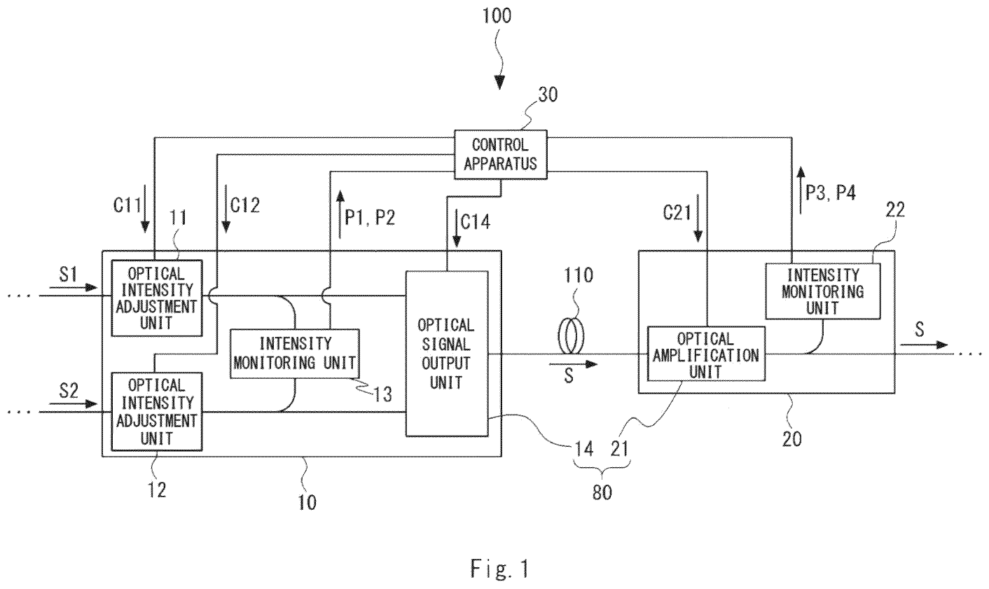

An optical communication system according to a first example embodiment will be described. FIG. 1 is a block diagram schematically illustrating a basic configuration of the optical communication system according to the example embodiment. The optical communication system 100 in FIG. 1 includes optical communication apparatuses 10 and 20 and a control apparatus 30. The optical communication apparatuses 10 and 20 are hereinafter also referred to as first and second optical communication apparatuses, respectively.

The optical communication apparatus 10 is an optical communication apparatus on the upstream side and adjusts the intensity of an input optical signal. Then, the optical communication apparatus 10 outputs the optical signal after the intensity adjustment to an optical transmission line 110. For example, the optical communication apparatus 10 is placed on the light output side of an optical transmitter and an optical repeater.

The optical communication apparatus 10 includes optical intensity adjustment units 11 and 12, an intensity monitoring unit 13, and an optical signal output unit 14. The optical intensity adjustment unit 11 adjusts the intensity of an optical signal S1 at a wavelength λ1 input to the optical intensity adjustment unit 11, in accordance with a control signal C11 provided from the control apparatus 30. Then, the optical intensity adjustment unit 11 outputs the optical signal S1 after the intensity adjustment. The optical intensity adjustment unit 12 adjusts the intensity of an optical signal S2 at a wavelength λ2 input to the optical intensity adjustment unit 12, in accordance with a control signal C12 provided from the control apparatus 30. Then, the optical intensity adjustment unit 12 outputs the optical signal S2 after the intensity adjustment. The wavelengths λ1 and λ2 are hereinafter also referred to as first and second wavelengths, respectively. The optical signals S1 and S2 are also referred to as first and second optical signals, respectively. The optical intensity adjustment units 11 and 12 are also referred to as first and second optical intensity adjustment units, respectively.

In the following description, the wavelength λ1 and the wavelength λ2 are wavelengths different from each other. Note that a wavelength herein refers to a band of an optical signal. Accordingly, channels on the optical signals S1 and S2 in optical communication to which a WDM technology is applied are channels different from each other. It is assumed in the present example embodiment that the wavelength λ1 is an L-band wavelength and the wavelength λ2 is a C-band wavelength.

The intensity monitoring unit 13 monitors the intensity P1 of the optical signal S1 output from the optical intensity adjustment unit 11. The intensity monitoring unit 13 monitors the intensity P2 of the optical signal S2 output from the optical intensity adjustment unit 12. The intensity monitoring unit 13 sends the respective intensities P1 and P2 of the optical signals S1 and S2 to the control apparatus 30. The intensity monitoring unit 13 is hereinafter also referred to as a first intensity monitoring unit. The intensities P1 and P2 are also referred to as first and second intensities, respectively.

The optical signal output unit 14 outputs a wavelength division multiplexed optical signal S acquired by wavelength division multiplexing the optical signal S1 and the optical signal S2 to the optical transmission line 110. A wavelength division multiplexed optical signal is hereinafter expressed as a WDM optical signal for the sake of simplification. Further, the optical signal output unit 14 can adjust the intensity of the wavelength division multiplexed optical signal S by adjusting an amount of attenuation of the wavelength division multiplexed optical signal S. The wavelength division multiplexed optical signal S is hereinafter also referred to as a third optical signal.

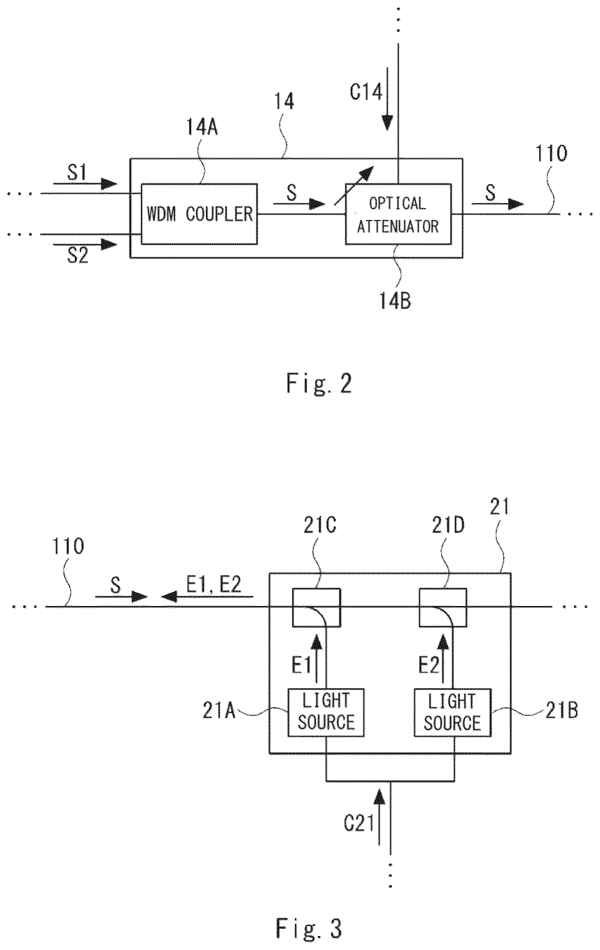

FIG. 2 is a diagram illustrating a configuration example of the optical signal output unit according to the example embodiment. In this example, the optical signal output unit 14 includes a WDM coupler 14A and an optical attenuator 14B. The WDM coupler 14A outputs the WDM optical signal S acquired by wavelength division multiplexing the optical signal S1 from the optical intensity adjustment unit 11 and the optical signal S2 from the optical intensity adjustment unit 12 to the optical attenuator 14B. The optical attenuator 14B adjusts an amount of attenuation of the WDM optical signal S in accordance with a control signal C14 provided from the control apparatus 30. Then, the optical attenuator 14B outputs the attenuated WDM optical signal S to the optical transmission line 110.

The optical communication apparatus 20 is an optical communication apparatus on the downstream side and amplifies an optical signal from the optical transmission line 110 as needed. Then, the optical communication apparatus 20 outputs the optical signal after the amplification. For example, the optical communication apparatus 10 is placed on the light input side of an optical receiver and an optical repeater. Further, the optical communication apparatus 20 outputs a monitoring result of the intensity of a received optical signal to the control apparatus 30.

The optical communication apparatus 20 includes an optical amplification unit 21 and an intensity monitoring unit 22. For example, the optical amplification unit 21 may be configured as an amplification means for amplifying the optical signals S1 and S2 on the optical transmission line 110 with Raman scattered light in accordance with a control signal C21 provided from the control apparatus 30. FIG. 3 is a diagram illustrating a configuration example of the optical amplification unit according to the example embodiment. In this example, the optical amplification unit 21 includes light sources 21A and 21B and optical couplers 21C and 21D. The light sources 21A and 21B output rays of light E1 and E2 with intensities based on the control signal C21, respectively. The rays of light E1 and E2 are coupled with the optical transmission line 110 by the optical couplers 21C and 21D, respectively, and are transmitted in a direction opposite to the WDM optical signal S. Consequently, the optical signal S1 wavelength division multiplexed in the WDM optical signal S is amplified by Raman scattered light being the ray of light E1 on the optical transmission line 110. The optical signal S2 wavelength division multiplexed in the WDM optical signal S is amplified by Raman scattered light being the ray of light E2 on the optical transmission line 110. The control apparatus 30 can adjust the gain of each of the optical signals S1 and S2 based on forward Raman amplification on the optical transmission line 110 by adjusting the output intensities of the rays of light E1 and E2 by controlling the light sources 21A and 21B.

The intensity monitoring unit 22 is configured to be able to monitor the respective intensities P3 and P4 of the optical signals S1 and S2 wavelength division multiplexed in the WDM optical signal S output from the optical amplification unit 21. The intensity monitoring unit 22 sends the respective intensities P3 and P4 of the optical signals S1 and S2 to the control apparatus 30. The intensity monitoring unit 22 is hereinafter also referred to as a second intensity monitoring unit. The intensities P3 and P4 are also referred to as third and fourth intensities.

The control apparatus 30 controls the optical communication apparatuses 10 and 20 with the control signals C11, C12, C14, and C21, based on monitoring results of the intensities of the optical signals output by the optical communication apparatuses 10 and 20. Note that the optical signal output unit 14 and the optical amplification unit 21 constitute an optical signal adjustment unit 80 adjusting the respective intensities of the optical signals S1 and S2 in this configuration. The control apparatus 30 controls the optical signal adjustment unit 80 with the control signals C14 and C21.

While the control apparatus 30 is provided outside the optical communication apparatus 10 and the optical communication apparatus 20 in FIG. 1, the control apparatus 30 may be provided inside the optical communication apparatus 10 or the optical communication apparatus 20. Further, the optical communication apparatus 10 and the optical communication apparatus 20 may integrally constitute the control apparatus 30.

The optical communication system 100 adjusts the span losses of the optical signals S1 and S2 by using an adjustment of an amount of attenuation of the WDM optical signal S in the optical signal output unit 14 and an adjustment of the gains of the optical signals S1 and S2 at the time of amplification in the optical amplification unit 21. An operation of adjusting an amount of attenuation of the WDM optical signal S in the optical signal output unit 14 is hereinafter referred to as an attenuation adjustment. An operation of adjusting the gains of the optical signals S1 and S2 at the time of amplification in the optical amplification unit 21 is referred to as a gain adjustment.

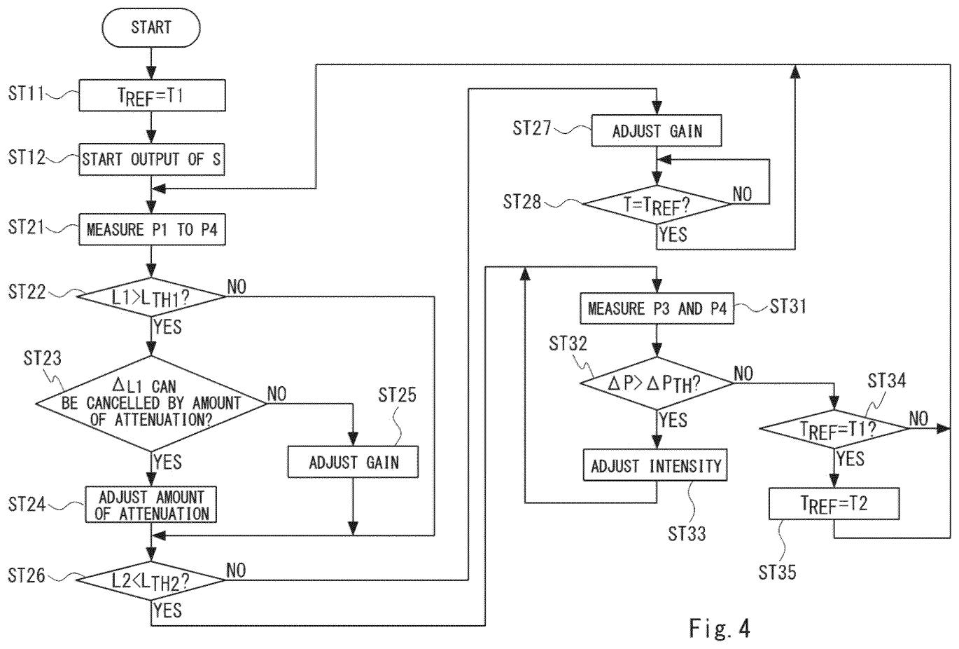

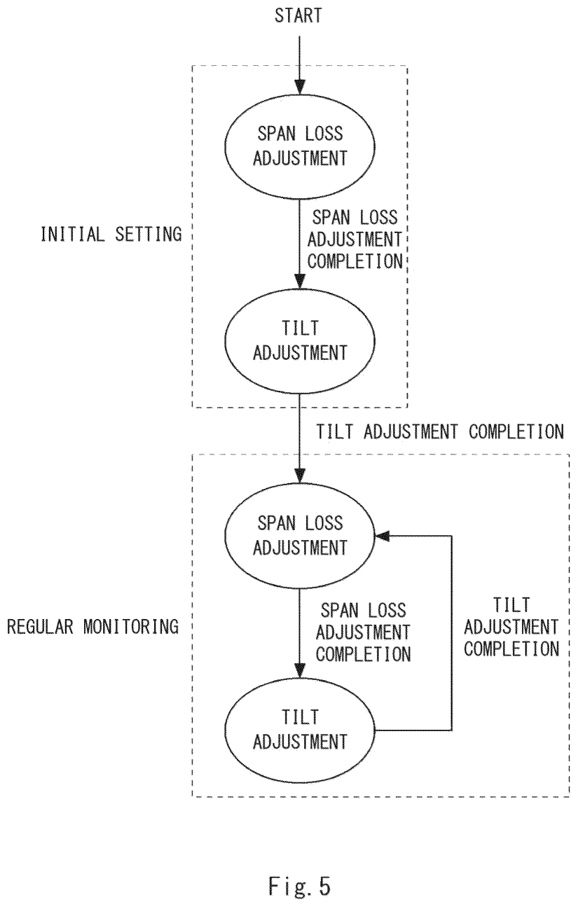

Next, an optical signal adjustment operation in the optical communication system 100 will be described. FIG. 4 is a flowchart of the optical signal adjustment operation in the optical communication system according to the example embodiment. FIG. 5 is a state transition diagram in the optical signal adjustment operation in the optical communication system according to the example embodiment.

As illustrated in FIG. 4, the optical communication system 100 adjusts the respective intensities of the optical signals S1 and S2 wavelength division multiplexed in the WDM optical signal S received by the optical communication apparatus 20, by repeatedly performing a span loss adjustment and an intensity difference adjustment.

After the optical signal adjustment operation is started, the optical communication system 100 first performs an initial operation in Steps ST11 and ST12 described below.

### Step ST11

The control apparatus 30 sets a reference time for initial setting T1 as a reference time T_{REF} indicating a repetition cycle of the span loss adjustment. Consequently, a span loss adjustment and an intensity difference adjustment as the initial setting operation are performed.

### Step ST12

The control apparatus 30 instructs the optical signal output unit 14 to start output of the WDM optical signal S. For example, the control apparatus 30 may control the optical signal output unit 14 in such a way that an amount of attenuation of the WDM optical signal S in the optical signal output unit 14 is maximized before the start of the optical signal adjustment operation and the amount of attenuation of the WDM optical signal S in the optical signal output unit 14 takes on a predetermined value after the start of the optical signal adjustment operation.

Further, for example, other than the control of the optical signal output unit 14, the optical communication apparatuses 10 and 20 may be controlled in such a way that the output intensities of the optical signals S1 and S2 from the optical intensity adjustment units 11 and 12 are minimized before the start of the optical signal adjustment operation and an amount of attenuation of the WDM optical signal S in the optical signal output unit 14 takes on a predetermined value after the start of the optical signal adjustment operation.

Furthermore, for example, other than the control of the optical signal output unit 14, a start and a stop of output of the WDM optical signal S may be controlled by controlling a separately provided light blocking means of the WDM optical signal S and transmission means of the optical signals S1 and S2.

Next, in Steps ST21 to ST28, the control apparatus 30 adjusts the span loss of an optical signal between the optical communication apparatus 10 and the optical communication apparatus 20.

### Step ST21

The intensity monitoring unit 13 measures the intensity P1 of the optical signal S1 and the intensity P2 of the optical signal S2 in the optical communication apparatus 10. The intensity monitoring unit 13 sends the measured intensity P1 of the optical signal S1 and the measured intensity P2 of the optical signal S2 to the control apparatus 30. The intensity monitoring unit 22 measures the intensity P3 of the optical signal S1 and the intensity P4 of the optical signal S2 in the optical communication apparatus 20. The intensity monitoring unit 22 sends the measured intensity P3 of the optical signal S1 and the measured intensity P4 of the optical signal S2 to the control apparatus 30.

### Step ST22

The control apparatus 30 determines whether a span loss L1 represented by the difference P1-P3 between the intensity P1 of the optical signal S1 on the upstream side and the intensity P3 of the optical signal S1 on the downstream side is greater than a reference value L_{TH1}. When the span loss L1 is less than the reference value L_{TH1}, the control apparatus 30 advances the processing to Step ST26. The span loss L1 is hereinafter also referred to as a first span loss.

### Step ST23

When the span loss L1 is greater than the reference value L_{TH1}, the control apparatus 30 determines whether the difference ΔL1 between the span loss L1 and the reference value L_{TH1} is a value that can be canceled when an amount of attenuation in the optical signal output unit 14 is changed from a previously set amount of attenuation to a minimum amount of attenuation or a maximum amount of attenuation. The determination processing in Step ST23 is hereinafter also referred to as a first determination.

### Step ST24

When the difference ΔL1 can be canceled by an attenuation adjustment by the optical signal output unit 14, the control apparatus 30 adjusts the amount of attenuation in the optical signal output unit 14 in such a way as to decrease the difference ΔL1. An adjustment width ΔA of the amount of attenuation when Step ST24 is executed once is limited to an upper adjustment width limit A_{MAX}. The fineness of the attenuation adjustment can be controlled by setting the upper adjustment width limit A_{MAX} to a suitable value. The span loss adjustment in Step ST24 is hereinafter also referred to as a first span loss adjustment. The upper adjustment width limit A_{MAX} is also referred to as a first attenuation adjustment width.

### Step ST25

When the difference ΔL1 cannot be canceled by an attenuation adjustment by the optical signal output unit 14, the control apparatus 30 adjusts the gain of the optical signal S1 in the optical amplification unit 21 in such a way as to decrease the difference ΔL1. Note that the amount of attenuation in the optical signal output unit 14 is preferably minimized in this processing. An adjustment width ΔG1 of the gain to be adjusted when Step ST23 is executed once is limited to an upper adjustment width limit G1_{MAX}. The fineness of the gain adjustment can be controlled by setting the upper adjustment width limit G1_{MAX} to a suitable value. The span loss adjustment in Step ST25 is hereinafter also referred to as a second span loss adjustment. The gain of the optical signal S1 in the optical amplification unit 21 is also referred to as a first gain. The upper adjustment width limit G1_{MAX} is also referred to as a first gain adjustment width.

### Step ST26

The control apparatus 30 determines whether a span loss L2 represented by the difference P2-P4 between the intensity P2 of the optical signal S2 on the upstream side and the intensity P4 of the optical signal S1 on the downstream side is less than a reference value L_{TH2}. When the span loss L2 is less than the reference value L_{TH2}, the control apparatus 30 advances the processing to Step ST31. The span loss L2 is hereinafter also referred to as a second span loss.

### Step ST27

When the span loss L2 is greater than the reference value L_{TH2}, the control apparatus 30 performs a span loss adjustment of the optical signal S2. At this time, an attenuation adjustment may have been performed at the time of a span loss adjustment of the optical signal S1. In this case, when an attenuation adjustment is performed again for a span loss adjustment of the optical signal S2, the span loss adjustment of the optical signal S1 is reset. Therefore, the span loss is adjusted solely by a gain adjustment for the optical signal S2. Accordingly, the control apparatus 30 adjusts the gain of the optical signal S2 in the optical amplification unit 21 in such a way as to decrease the difference ΔL2 between the span loss L2 and the reference value L_{TH2}. An adjustment width ΔG2 of the gain to be adjusted when Step ST27 is executed once is limited to an upper adjustment width limit G2_{MAX}. The fineness of the gain adjustment can be controlled by setting the upper adjustment width limit G2_{MAX} to a suitable value. The span loss adjustment in Step ST27 is hereinafter also referred to as a third span loss adjustment. The gain of the optical signal S2 in the optical amplification unit 21 is also referred to as a second gain. The upper adjustment width limit G2_{MAX} is also referred to as a second gain adjustment width.

### Step ST28

The control apparatus 30 measures an elapsed time T after the adjustment of the gain of the optical signal S2 in the optical amplification unit 21. Then, the control apparatus 30 monitors whether the elapsed time T reaches the reference time T_{REF}. When the elapsed time T reaches the reference time T_{REF}, the control apparatus 30 returns the processing to Step ST21.

When the span loss L2 is less than the reference value L_{TH2}, the optical communication system 100 temporarily completes the span loss adjustment and makes a transition to an intensity difference adjustment in Steps ST31 to ST35. The span loss of each of the optical signals S1 and S2 is converged to a value less than a predetermined value in Steps ST21 to ST28. However, it is assumed in this state that the losses are unbalanced due to an effect such as stimulated Raman scattering (SRS) tilt and that the intensity P3 of the optical signal S1 and the intensity P4 of the optical signal S2 on the downstream side are unbalanced. Then, the control apparatus 30 performs the intensity difference adjustment in Steps ST31 to ST35 described below in such a way that the difference between the intensity P3 of the optical signal S1 and the intensity P4 of the optical signal S2 is less than a predetermined value.

### Step ST31

The intensity monitoring unit 22 measures the intensity P3 of the optical signal S1 and the intensity P4 of the optical signal S2 in the optical communication apparatus 20. The intensity monitoring unit 22 sends the measured intensity P3 of the optical signal S1 and the measured intensity P4 of the optical signal S2 to the control apparatus 30.

### Step ST32

The control apparatus 30 determines whether the intensity difference ΔP between the intensity P3 of the optical signal S1 and the intensity P4 of the optical signal S2 on the downstream side is greater than a reference value ΔP_{TH}. When the intensity difference ΔP is less than the reference value ΔP_{TH}, the control apparatus 30 advances the processing to Step ST34.

### Step ST33

When the intensity difference ΔP is greater than the reference value ΔP_{TH}, the control apparatus 30 adjusts at least one of the intensity P1 of the optical signal S1 and the intensity P2 of the optical signal S2 to decrease the intensity difference ΔP.

A case of the control apparatus 30 controlling both of the optical intensity adjustment units 11 and 12 will be described. To make the intensity difference between the intensity P1 of the optical signal S1 and the intensity P2 of the optical signal S2 on the upstream side less than the reference value ΔP_{TH}, the control apparatus 30 determines the intensity P1 of the optical signal S1 and the intensity P2 of the optical signal S2 on the upstream side, based on the intensity P3 of the optical signal S1 and the intensity P4 of the optical signal S2 on the downstream side. Then, the control apparatus 30 indicates the determined intensities P1 and P2 to the optical intensity adjustment units 11 and 12.

The optical intensity adjustment unit 11 performs an intensity adjustment in such a way that the intensity P1 of the optical signal S1 is the indicated value. The optical intensity adjustment unit 12 performs an intensity adjustment in such a way that the intensity P2 of the optical signal S2 is the indicated value. Subsequently, the processing is returned to Step ST31.

### Step ST34

When the intensity difference ΔP is less than the reference value ΔP_{TH}, the control apparatus 30 determines whether the reference time for initial setting T1 is set as the reference time T_{REF} indicating the repetition cycle of a span loss adjustment. When the reference time for regular monitoring T2 is set as the reference time T_{REF}, the control apparatus 30 returns the processing to Step ST21 after elapse of a predetermined time. Consequently, regular monitoring of the optical signals is continued.

### Step ST35

When the reference time for initial setting T1 is set as the reference time T_{REF}, the control apparatus 30 changes the reference time T_{REF} to the reference time for regular monitoring T2. The control apparatus 30 returns the processing to Step ST21 after elapse of a predetermined time. Consequently, the state of the optical communication system 100 makes a transition from the initial setting to the regular monitoring. From here onward, a span loss adjustment and an intensity difference adjustment as a regular monitoring operation are performed.

As described above, the optical communication system 100 enables an automatic and efficient initial setting operation including span loss adjustments and intensity difference adjustments of the optical signals S1 and S2 wavelength division multiplexed in the WDM optical signal S without depending on manual work.

Further, the optical communication system 100 also enables continuous intensity adjustments of the optical signals S1 and S2 by intermittently performing span loss adjustments and intensity difference adjustments of the optical signals S1 and S2 in the regular monitoring operation after the initial setting operation ends. Consequently, the optical signals S1 and S2 during operation of the optical communication system 100 can be automatically and efficiently maintained at desired quality.

The reference time for initial setting T1 used as the reference time T_{REF} indicating the repetition cycle of a span loss adjustment is desirably shorter than the reference time for regular monitoring T2 in the optical communication system 100. Consequently, a value of a span loss can be promptly converged to a value less than a reference value by repeatedly performing a span loss adjustment at the time of initial setting at a short cycle. On the other hand, intensity variations of an optical signal over time can be corrected by performing a span loss adjustment at the time of regular monitoring on a long cycle accommodating the variations over time.

In the optical communication system 100, an upper adjustment width limit for initial setting operation A_{MAX1} used as the upper adjustment width limit A_{MAX} of the adjustment width ΔA of an amount of attenuation desirably takes on a value greater than an upper adjustment width limit for regular monitoring operation A_{MAX2}.

Consequently, a coarse adjustment of changing an amount of attenuation of an optical signal at a large width can be performed at the time of initial setting operation. Accordingly, initial setting of a span loss can be promptly completed by controlling the number of repetitions of span loss adjustment. On the other hand, a fine adjustment of changing an amount of attenuation of an optical signal at a smaller width can be performed at the time of the regular monitoring operation. Accordingly, a precise span loss adjustment can be performed for variations of a span loss over time in which a small variation width is predicted.

Further, in the optical communication system 100, an upper adjustment width limit for initial setting operation G1_{MAX1} used as the upper adjustment width limit G1_{MAX} of the adjustment width ΔG1 of the gain of the optical signal S1 desirably takes on a value greater than an upper adjustment width limit for regular monitoring operation G1_{MAX2}. Consequently, a coarse adjustment of changing the gain of the optical signal S1 at a large width can be performed at the time of the initial setting operation. Accordingly, initial setting of a span loss can be promptly completed by controlling the number of repetitions of span loss adjustment. On the other hand, a fine adjustment of changing an amount of attenuation of an optical signal at a smaller width can be performed at the time of the regular monitoring operation. Accordingly, a precise span loss adjustment can be performed for variations of a span loss over time in which a small variation width is predicted.

Furthermore, in the optical communication system 100, an upper adjustment width limit for initial setting operation G2_{MAX1} used as the upper adjustment width limit G2_{MAX} of the adjustment width ΔG2 of the gain of the optical signal S2 desirably takes on a value greater than an upper adjustment width limit for regular monitoring operation G2_{MAX2}. Consequently, a coarse adjustment of changing the gain of the optical signal S2 at a large width can be performed at the initial setting operation. Accordingly, initial setting of a span loss can be promptly completed by controlling the number of repetitions of span loss adjustment. On the other hand, a fine adjustment of changing an amount of attenuation of an optical signal at a smaller width can be performed at the time of the regular monitoring operation.

Accordingly, a precise span loss adjustment can be performed for variations of a span loss over time in which a small variation width is predicted.

### Second Example Embodiment

A case of the optical communication apparatus 10 and the optical communication apparatus 20 according to the first example embodiment constituting an optical communication apparatus functioning as one repeater in an optical communication system will be described in the present example embodiment.

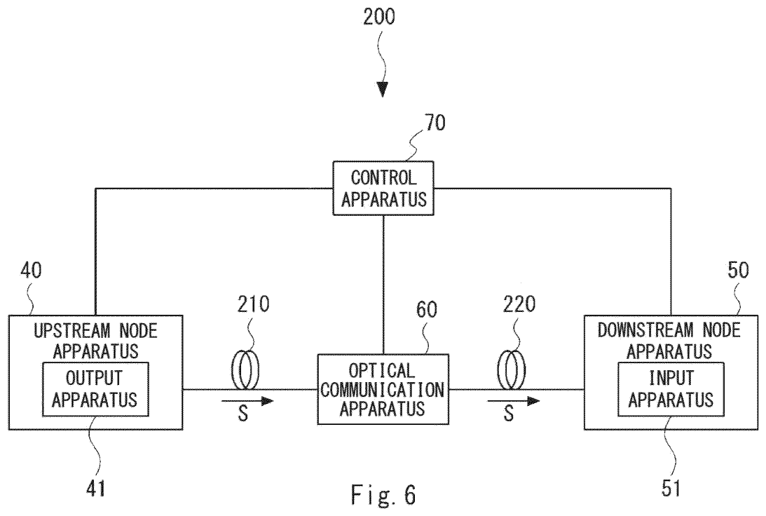

FIG. 6 is a block diagram schematically illustrating a configuration of an optical communication system according to the example embodiment. The optical communication system 200 includes an upstream node apparatus 40, a downstream node apparatus 50, an optical communication apparatus 60, and a control apparatus 70.

The upstream node apparatus 40 may be one of various optical communication apparatuses being inserted into an optical communication network and functioning as node apparatuses, such as an optical repeater, an optical transmitter, and an optical transceiver. The upstream node apparatus 40 at least includes an output apparatus 41 configured similarly to the optical communication apparatus 10 according to the first example embodiment. The output apparatus 41 transmits a WDM optical signal S to the optical communication apparatus 60 through an optical transmission line 210.

The optical communication apparatus 60 is configured as a repeater relaying the WDM optical signal S transmitted from the upstream node apparatus 40. The optical communication apparatus 60 at least includes an input apparatus configured similarly to the optical communication apparatus 20 according to the first example embodiment and an output apparatus configured similarly to the optical communication apparatus 10. The optical communication apparatus 60 performs predetermined processing on the input WDM optical signal S and then transmits the resulting signal to the downstream node apparatus 50 through an optical transmission line 220.

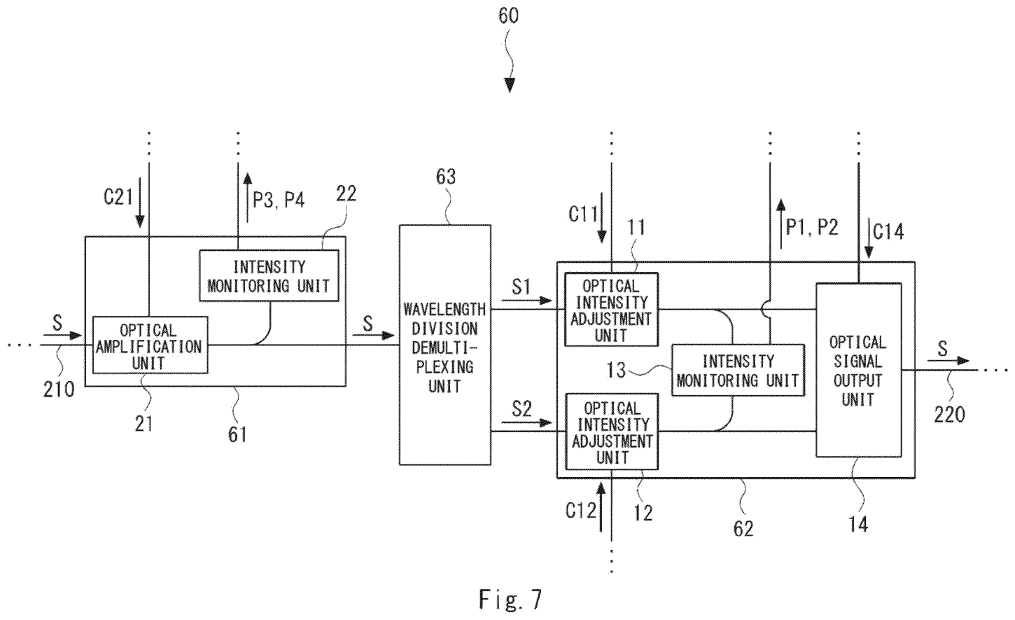

FIG. 7 is a block diagram schematically illustrating a configuration of the optical communication apparatus according to the example embodiment. The optical communication apparatus 60 includes an input apparatus 61, an output apparatus 62, and a wavelength division demultiplexing unit 63. The input apparatus 61 is configured similarly to the optical communication apparatus 20. The input apparatus 61 performs processing similar to that performed by the optical communication apparatus 20 on the input WDM optical signal S. Then, the input apparatus 61 outputs the WDM optical signal S undergoing the processing to the wavelength division demultiplexing unit 63 through an optical transmission line 64.

The wavelength division demultiplexing unit 63 wavelength division demultiplexes the WDM optical signal S into an optical signal S1 at a wavelength λ1 and an optical signal S2 at a wavelength λ2. Subsequently, the wavelength division demultiplexing unit 63 outputs the optical signals S1 and S2 to the output apparatus 62.

The output apparatus 62 is configured similarly to the optical communication apparatus 10. The input apparatus 61 performs processing similar to that performed by the optical communication apparatus 20 on the input optical signals S1 and S2. Then, the output apparatus 62 transmits the WDM optical signal S to the downstream node apparatus 50 through the optical transmission line 220.

The downstream node apparatus 50 may be one of various optical communication apparatuses being inserted into an optical communication network and functioning as node apparatuses, such as an optical repeater, an optical receiver, and an optical transceiver. The downstream node apparatus 50 at least includes an input apparatus 51 configured similarly to the optical communication apparatus 20 according to the first example embodiment. The WDM optical signal S is input to the input apparatus 51 from the optical communication apparatus 60 through the optical transmission line 220.

In the optical communication system 200, the output apparatus 41 in the upstream node apparatus 40 and the input apparatus 61 in the optical communication apparatus 60 are paired with each other and can perform an optical signal adjustment operation similarly to the optical communication apparatuses 10 and 20. Further, the output apparatus 62 in the optical communication apparatus 60 and the input apparatus 51 in the downstream node apparatus 50 are paired with each other and can perform an optical signal adjustment operation similarly to the optical communication apparatuses 10 and 20. It goes without saying that the optical signal adjustment operations can be achieved by the control apparatus 70 providing control signals to the upstream node apparatus 40, the downstream node apparatus 50, and the optical communication apparatus 60, similarly to the control apparatus 30.

While the control apparatus 70 is provided outside the upstream node apparatus 40 and the downstream node apparatus 50 in FIG. 6, the control apparatus 70 may be provided inside the upstream node apparatus 40 or the downstream node apparatus 50. Further, the upstream node apparatus 40 and the downstream node apparatus 50 may integrally constitute the control apparatus 70.

It can be understood from the description above that the optical communication apparatus 60 can perform the optical signal adjustment operations in relaying of an optical signal as well, similarly to the first example embodiment, in cooperation with the upstream node apparatus 40 and the downstream node apparatus 50.

### Other Example Embodiments

While the present disclosure has been described above with reference to the example embodiments, the present disclosure is not limited to the above-described example embodiments. Various changes and modifications that may be understood by one of ordinary skill in the art can be made to the configurations and details of the present disclosure within the scope of the present disclosure. Then, each example embodiment may be appropriately combined with another example embodiment.

The configuration of the optical signal output unit is merely an example. Various configurations may be employed as long as the configuration allows output of the wavelength division multiplexed optical signal S acquired by wavelength division multiplexing the optical signals S1 and S2 and adjustment of an amount of attenuation of the wavelength division multiplexed optical signal S.

The configuration of the intensity monitoring unit 22 is merely an example. Various configurations may be employed as long as the configuration allows amplification of each of the optical signals S1 and S2.

While the wavelength λ1 is assumed to be a C-band wavelength and the wavelength λ2 is assumed to be an L-band wavelength in the above-described example embodiments, the above is merely an example. The wavelengths λ1 and λ2 may be any wavelengths as long as the wavelength λ1 is shorter than the wavelength λ2.

When a value of interest is equal to a reference value in a comparison between the value of interest and the reference value in the above-described example embodiments, the case may be included in a case of the value of interest being greater than the reference value or a case of the value of interest being less than the reference value.

Each drawing is simply an example for describing one or more example embodiments. Instead of being associated with only one specific example embodiment, each drawing may be associated with one or more other example embodiments. As may be understood by one of ordinary skill in the art, for example, various features or steps described with reference to one of the drawings may be combined with features or steps illustrated in one or more other diagrams to create an example embodiment not being explicitly illustrated or described. Not all the features or steps illustrated in any of the diagrams to describe an example embodiment are necessarily essential, and part of the features or steps may be omitted. The order of steps described in any of the diagrams may be changed as appropriate.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The whole or part of the example embodiments described above may also be described as, but not limited to, the following supplementary notes.

### (Supplementary Note 1)

An optical communication system including: a first optical communication apparatus configured to output a third optical signal acquired by wavelength division multiplexing a first optical signal at a first wavelength and a second optical signal at a second wavelength different from the first wavelength; a second optical communication apparatus configured to be able to amplify the third optical signal input from the first optical communication apparatus through an optical transmission line; an optical signal adjustment means for being able to adjust an intensity of each of the first and second optical signals wavelength division multiplexed in the third optical signal in the second optical communication apparatus; and a control apparatus configured to control the first optical communication apparatus and the optical signal adjustment means, wherein the first optical communication apparatus includes: a first intensity adjustment means for adjusting an intensity of the first optical signal; a second intensity adjustment means for adjusting an intensity of the second optical signal; a multiplexing means for outputting the third optical signal acquired by wavelength division multiplexing the first optical signal and the second optical signal to the optical transmission line; and a first intensity monitoring means for monitoring a first intensity being an intensity of the first optical signal input to the multiplexing means and a second intensity being an intensity of the second optical signal input to the multiplexing means, the second optical communication apparatus includes a second intensity monitoring means for monitoring a third intensity being an intensity of the first optical signal wavelength division multiplexed in the third optical signal and a fourth intensity being an intensity of the second optical signal wavelength division multiplexed in the third optical signal in the second optical communication apparatus, and the control apparatus can perform: span loss adjustment processing of adjusting a span loss of the first optical signal by controlling the optical signal adjustment means, based on the first intensity and the third intensity, and adjusting a span loss of the second optical signal by controlling the optical signal adjustment means, based on the second intensity and the fourth intensity; and intensity difference adjustment processing of adjusting an intensity difference between the first optical signal and the second optical signal after a span loss adjustment in the second optical communication apparatus by controlling at least one of the first and second intensity adjustment means, performs the span loss adjustment processing and the intensity difference adjustment processing as an initial setting operation after output of the third optical signal from the first optical communication apparatus starts, and performs a monitoring operation of repeating the span loss adjustment processing and the intensity difference adjustment processing on a predetermined cycle after the initial setting operation ends.

### (Supplementary Note 2)

The optical communication system according to supplementary note 1, wherein the multiplexing means attenuates the input third optical signal and outputs the attenuated third optical signal, the second optical communication apparatus further includes an optical amplification means for being able to amplify each of the first and second optical signals wavelength division multiplexed in the third optical signal, the second intensity monitoring means monitors intensities of the first and second optical signals wavelength division multiplexed in the third optical signal output from the optical amplification means as the third and fourth intensities, respectively, the optical signal adjustment means is configured with the multiplexing means and the optical amplification means, and the control apparatus performs the span loss adjustment processing by adjusting an amount of attenuation of the third optical signal in the multiplexing means, and a first gain of the first optical signal and a second gain of the second optical signal that are provided by the optical amplification means.

### (Supplementary Note 3)

The optical communication system according to supplementary note 2, wherein the control apparatus performs: a first determination of determining whether a first span loss of the first optical signal is adjustable by the amount of attenuation by the multiplexing means; a first span loss adjustment of adjusting a first span loss of the first optical signal by adjusting the amount of attenuation by the multiplexing means in a case where the first span loss is adjustable by the amount of attenuation by the multiplexing means; and a second span loss adjustment of adjusting the first span loss by adjusting the first gain in the optical amplification means in a case where the first span loss is not adjustable by the amount of attenuation by the multiplexing means.

### (Supplementary Note 4)

The optical communication system according to supplementary note 3, wherein an adjustment width of the amount of attenuation by the multiplexing means is limited to a first attenuation adjustment width, an adjustment width of the first gain is limited to a first gain adjustment width, and the control apparatus repeats the first determination and one of the first and second span loss adjustments until the first span loss is less than a predetermined value.

### (Supplementary Note 5)

The optical communication system according to supplementary note 4, wherein the control apparatus performs a third span loss adjustment of adjusting the second span loss of the second optical signal by adjusting the second gain in the optical amplification means.

### (Supplementary Note 6)

The optical communication system according to supplementary note 5, wherein an adjustment width of the second gain is limited to a second gain adjustment width, and the control apparatus repeats the third span loss adjustment until the second span loss is less than a predetermined value.

### (Supplementary Note 7)

The optical communication system according to supplementary note 6, wherein a repetition cycle of the first to third span loss adjustments in the initial setting operation is shorter than a repetition cycle of the first to third span loss adjustments in the monitoring operation.

### (Supplementary Note 8)

The optical communication system according to supplementary note 6 or 7, wherein the first attenuation adjustment width in the initial setting operation is greater than the first attenuation adjustment width in the monitoring operation, the first gain adjustment width in the initial setting operation is greater than the first gain adjustment width in the monitoring operation, and the second gain adjustment width in the initial setting operation is greater than the second gain adjustment width in the monitoring operation.

### (Supplementary Note 9)

An optical signal control method including, in an optical communication system including: a first optical communication apparatus configured to output a third optical signal acquired by wavelength division multiplexing a first optical signal at a first wavelength and a second optical signal at a second wavelength different from the first wavelength; a second optical communication apparatus configured to be able to amplify the third optical signal input from the first optical communication apparatus through an optical transmission line; and an optical signal adjustment means for being able to adjust an intensity of each of the first and second optical signals wavelength division multiplexed in the third optical signal in the second optical communication apparatus, wherein the first optical communication apparatus includes: a first intensity adjustment means for adjusting an intensity of the first optical signal; a second intensity adjustment means for adjusting an intensity of the second optical signal; a multiplexing means for outputting the third optical signal acquired by wavelength division multiplexing the first optical signal and the second optical signal to the optical transmission line; and a first intensity monitoring means for monitoring a first intensity being an intensity of the first optical signal input to the multiplexing means and a second intensity being an intensity of the second optical signal input to the multiplexing means, and the second optical communication apparatus includes a second intensity monitoring means for monitoring a third intensity being an intensity of the first optical signal wavelength division multiplexed in the third optical signal and a fourth intensity being an intensity of the second optical signal wavelength division multiplexed in the third optical signal in the second optical communication apparatus: performing: span loss adjustment processing of adjusting a span loss of the first optical signal by controlling the optical signal adjustment means, based on the first intensity and the third intensity, and adjusting a span loss of the second optical signal by controlling the optical signal adjustment means, based on the second intensity and the fourth intensity; and intensity difference adjustment processing of adjusting an intensity difference between the first optical signal and the second optical signal after a span loss adjustment in the second optical communication apparatus by controlling at least one of the first and second intensity adjustment means; performing the span loss adjustment processing and the intensity difference adjustment processing as an initial setting operation after output of the third optical signal from the first optical communication apparatus starts; and performing a monitoring operation of repeating the span loss adjustment processing and the intensity difference adjustment processing on a predetermined cycle after the initial setting operation ends.

### (Supplementary Note 10)

An optical communication apparatus including: a first light input means for being able to amplify a first wavelength division multiplexed optical signal being acquired by wavelength division multiplexing a first optical signal at a first wavelength and a second optical signal at a second wavelength different from the first wavelength and being input from a second light output means through a first optical transmission line; a wavelength division demultiplexing means for wavelength division demultiplexing the first wavelength division multiplexed optical signal into the first optical signal and the second optical signal; and a first light output means for outputting a second wavelength division multiplexed optical signal acquired by wavelength division multiplexing the first optical signal and the second optical signal that are wavelength division demultiplexed by the wavelength division demultiplexing means to a second light input means through a second optical transmission line, wherein a first optical signal adjustment means can adjust an intensity of each of the first and second optical signals wavelength division multiplexed in the first wavelength division multiplexed optical signal in the first light input means, a second optical signal adjustment means can adjust an intensity of each of the first and second optical signals wavelength division multiplexed in the second wavelength division multiplexed optical signal in the second light input means, a control apparatus controls the first and second light output means and the first and second optical signal adjustment means, each of the first and second light output means includes: a first intensity adjustment means for adjusting an intensity of the first optical signal; a second intensity adjustment means for adjusting an intensity of the second optical signal; a multiplexing means for outputting a wavelength division multiplexed optical signal acquired by wavelength division multiplexing the first optical signal and the second optical signal; and a first intensity monitoring means for monitoring a first intensity being an intensity of the first optical signal input to the multiplexing means and a second intensity being an intensity of the second optical signal input to the multiplexing means, each of the first and second light input means includes a second intensity monitoring means for monitoring, inside each means, a third intensity being an intensity of the first optical signal wavelength division multiplexed in an input wavelength division multiplexed optical signal and a fourth intensity being an intensity of the second optical signal wavelength division multiplexed in the input wavelength division multiplexed optical signal, between the first light output means and the first light input means, the control apparatus can perform: span loss adjustment processing of adjusting a span loss of the first optical signal by controlling the first optical signal adjustment means, based on the first intensity and the third intensity, and adjusting a span loss of the second optical signal by controlling the first optical signal adjustment means, based on the second intensity and the fourth intensity; and intensity difference adjustment processing of adjusting an intensity difference between the first optical signal and the second optical signal after a span loss adjustment in the first light input means by controlling at least one of the first and second intensity adjustment means, performs the span loss adjustment processing and the intensity difference adjustment processing as an initial setting operation after output of the first wavelength division multiplexed optical signal from the first light output means starts, and performs a monitoring operation of repeating the span loss adjustment processing and the intensity difference adjustment processing on a predetermined cycle after the initial setting operation ends, and, between the second light output means and the second light input means, the control apparatus further can perform: span loss adjustment processing of adjusting a span loss of the first optical signal by controlling the second optical signal adjustment means, based on the first intensity and the third intensity, and adjusting a span loss of the second optical signal by controlling the second optical signal adjustment means, based on the second intensity and the fourth intensity; and intensity difference adjustment processing of adjusting an intensity difference between the first optical signal and the second optical signal after a span loss adjustment in the second light input means by controlling at least one of the first and second intensity adjustment means, performs the span loss adjustment processing and the intensity difference adjustment processing as an initial setting operation after output of the second wavelength division multiplexed optical signal from the second light output means starts, and performs a monitoring operation of repeating the span loss adjustment processing and the intensity difference adjustment processing on a predetermined cycle after the initial setting operation ends.

What is claimed is:

1. An optical communication system comprising:
a first optical communication apparatus configured to output a third optical signal acquired by wavelength division multiplexing a first optical signal at a first wavelength and a second optical signal at a second wavelength different from the first wavelength;
a second optical communication apparatus configured to be able to amplify the third optical signal input from the first optical communication apparatus through an optical transmission line;
an optical signal adjustment unit configured to be able to adjust an intensity of each of the first and second optical signals wavelength division multiplexed in the third optical signal in the second optical communication apparatus; and
a control apparatus configured to control the first optical communication apparatus and the optical signal adjustment unit, wherein
the first optical communication apparatus includes:
a first intensity adjustment unit configured to adjust an intensity of the first optical signal;
a second intensity adjustment unit configured to adjust an intensity of the second optical signal;
a multiplexing unit configured to output the third optical signal acquired by wavelength division multiplexing the first optical signal and the second optical signal to the optical transmission line; and
a first intensity monitoring unit configured to monitor a first intensity being an intensity of the first optical signal input to the multiplexing unit and a second intensity being an intensity of the second optical signal input to the multiplexing unit,
the second optical communication apparatus includes a second intensity monitoring unit configured to monitor a third intensity being an intensity of the first optical signal wavelength division multiplexed in the third optical signal and a fourth intensity being an intensity of the second optical signal wavelength division multiplexed in the third optical signal in the second optical communication apparatus, and
the control apparatus
can perform:
span loss adjustment processing of adjusting a span loss of the first optical signal by controlling the optical signal adjustment unit, based on the first intensity and the third intensity, and adjusting a span loss of the second optical signal by controlling the optical signal adjustment unit, based on the second intensity and the fourth intensity; and
intensity difference adjustment processing of adjusting an intensity difference between the first optical signal and the second optical signal after a span loss adjustment in the second optical communication apparatus by controlling at least one of the first and second intensity adjustment units,
performs the span loss adjustment processing and the intensity difference adjustment processing as an initial setting operation after output of the third optical signal from the first optical communication apparatus starts, and
performs a monitoring operation of repeating the span loss adjustment processing and the intensity difference adjustment processing on a predetermined cycle after the initial setting operation ends.

2. The optical communication system according to claim 1, wherein
the multiplexing unit attenuates the input third optical signal and outputs the attenuated third optical signal,
the second optical communication apparatus further includes an optical amplification unit configured to be able to amplify each of the first and second optical signals wavelength division multiplexed in the third optical signal,
the second intensity monitoring unit monitors intensities of the first and second optical signals wavelength division multiplexed in the third optical signal output from the optical amplification unit as the third and fourth intensities, respectively,
the optical signal adjustment unit is configured with the multiplexing unit and the optical amplification unit, and
the control apparatus performs the span loss adjustment processing by adjusting an amount of attenuation of the third optical signal in the multiplexing unit, and a first gain of the first optical signal and a second gain of the second optical signal that are provided by the optical amplification unit.

3. The optical communication system according to claim 2, wherein the control apparatus performs:
a first determination of determining whether a first span loss of the first optical signal is adjustable by an amount of attenuation by the multiplexing unit;
a first span loss adjustment of adjusting the first span loss of the first optical signal by adjusting the amount of attenuation by the multiplexing unit in a case where the first span loss is adjustable by the amount of attenuation by the multiplexing unit; and
a second span loss adjustment of adjusting the first span loss by adjusting the first gain in the optical amplification unit in a case where the first span loss is not adjustable by the amount of attenuation by the multiplexing unit.

4. The optical communication system according to claim 3, wherein
an adjustment width of the amount of attenuation by the multiplexing unit is limited to a first attenuation adjustment width,
an adjustment width of the first gain is limited to a first gain adjustment width, and
the control apparatus repeats the first determination and one of the first and second span loss adjustments until the first span loss is less than a predetermined value.

5. The optical communication system according to claim 4, wherein the control apparatus performs a third span loss adjustment of adjusting the second span loss of the second optical signal by adjusting the second gain in the optical amplification unit.

6. The optical communication system according to claim 5, wherein
an adjustment width of the second gain is limited to a second gain adjustment width, and
the control apparatus repeats the third span loss adjustment until the second span loss is less than a predetermined value.

7. The optical communication system according to claim 6, wherein a repetition cycle of the first to third span loss adjustments in the initial setting operation is shorter than a repetition cycle of the first to third span loss adjustments in the monitoring operation.

8. The optical communication system according to claim 6, wherein
the first attenuation adjustment width in the initial setting operation is greater than the first attenuation adjustment width in the monitoring operation,
the first gain adjustment width in the initial setting operation is greater than the first gain adjustment width in the monitoring operation, and
the second gain adjustment width in the initial setting operation is greater than the second gain adjustment width in the monitoring operation.

9. An optical signal control method comprising, in an optical communication system including:
a first optical communication apparatus configured to output a third optical signal acquired by wavelength division multiplexing a first optical signal at a first wavelength and a second optical signal at a second wavelength different from the first wavelength;
a second optical communication apparatus configured to be able to amplify the third optical signal input from the first optical communication apparatus through an optical transmission line; and
an optical signal adjustment unit configured to be able to adjust an intensity of each of the first and second optical signals wavelength division multiplexed in the third optical signal in the second optical communication apparatus, wherein
the first optical communication apparatus includes:
a first intensity adjustment unit configured to adjust an intensity of the first optical signal;
a second intensity adjustment configured to adjust an intensity of the second optical signal;
a multiplexing configured to output the third optical signal acquired by wavelength division multiplexing the first optical signal and the second optical signal to the optical transmission line; and
a first intensity monitoring unit configured to monitor a first intensity being an intensity of the first optical signal input to the multiplexing unit and a second intensity being an intensity of the second optical signal input to the multiplexing unit, and
the second optical communication apparatus includes a second intensity monitoring unit configured to monitor a third intensity being an intensity of the first optical signal wavelength division multiplexed in the third optical signal and a fourth intensity being an intensity of the second optical signal wavelength division multiplexed in the third optical signal in the second optical communication apparatus:
performing:
span loss adjustment processing of adjusting a span loss of the first optical signal by controlling the optical signal adjustment unit, based on the first intensity and the third intensity, and adjusting a span loss of the second optical signal by controlling the optical signal adjustment unit, based on the second intensity and the fourth intensity; and
intensity difference adjustment processing of adjusting an intensity difference between the first optical signal and the second optical signal after a span loss adjustment in the second optical communication apparatus by controlling at least one of the first and second intensity adjustment units;
performing the span loss adjustment processing and the intensity difference adjustment processing as an initial setting operation after output of the third optical signal from the first optical communication apparatus starts; and
performing a monitoring operation of repeating the span loss adjustment processing and the intensity difference adjustment processing on a predetermined cycle after the initial setting operation ends.

10. An optical communication apparatus comprising:
a first light input unit configured to be able to amplify a first wavelength division multiplexed optical signal being acquired by wavelength division multiplexing a first optical signal at a first wavelength and a second optical signal at a second wavelength different from the first wavelength and being input from a second light output unit through a first optical transmission line;
a wavelength division demultiplexing unit configured to wavelength division demultiplex the first wavelength division multiplexed optical signal into the first optical signal and the second optical signal; and
a first light output unit configured to output a second wavelength division multiplexed optical signal acquired by wavelength division multiplexing the first optical signal and the second optical signal that are wavelength division demultiplexed by the wavelength division demultiplexing unit to a second light input unit through a second optical transmission line, wherein
a first optical signal adjustment unit configured to be able to adjust an intensity of each of the first and second optical signals wavelength division multiplexed in the first wavelength division multiplexed optical signal in the first light input unit,
a second optical signal adjustment unit configured to be able to adjust an intensity of each of the first and second optical signals wavelength division multiplexed in the second wavelength division multiplexed optical signal in the second light input unit,
a control apparatus controls the first and second light output units and the first and second optical signal adjustment units,
each of the first and second light output units includes:
a first intensity adjustment unit configured to adjust an intensity of the first optical signal;
a second intensity adjustment unit configured to adjust an intensity of the second optical signal;
a multiplexing unit configured to output a wavelength division multiplexed optical signal acquired by wavelength division multiplexing the first optical signal and the second optical signal; and
a first intensity monitoring unit configured to monitor a first intensity being an intensity of the first optical signal input to the multiplexing unit and a second intensity being an intensity of the second optical signal input to the multiplexing unit,
each of the first and second light input units includes a second intensity monitoring unit for monitoring, inside each unit, a third intensity being an intensity of the first optical signal wavelength division multiplexed in an input wavelength division multiplexed optical signal and a fourth intensity being an intensity of the second optical signal wavelength division multiplexed in the input wavelength division multiplexed optical signal,
between the first light output unit and the first light input unit, the control apparatus
can perform:
span loss adjustment processing of adjusting a span loss of the first optical signal by controlling the first optical signal adjustment unit, based on the first intensity and the third intensity, and adjusting a span loss of the second optical signal by controlling the first optical signal adjustment unit, based on the second intensity and the fourth intensity; and
intensity difference adjustment processing of adjusting an intensity difference between the first optical signal and the second optical signal after a span loss adjustment in the first light input unit by controlling at least one of the first and second intensity adjustment units,
performs the span loss adjustment processing and the intensity difference adjustment processing as an initial setting operation after output of the first wavelength division multiplexed optical signal from the first light output unit starts, and
performs a monitoring operation of repeating the span loss adjustment processing and the intensity difference adjustment processing on a predetermined cycle after the initial setting operation ends, and,
between the second light output unit and the second light input unit, the control apparatus further
can perform:
span loss adjustment processing of adjusting a span loss of the first optical signal by controlling the second optical signal adjustment unit, based on the first intensity and the third intensity, and adjusting a span loss of the second optical signal by controlling the second optical signal adjustment unit, based on the second intensity and the fourth intensity; and
intensity difference adjustment processing of adjusting an intensity difference between the first optical signal and the second optical signal after a span loss adjustment in the second light input unit by controlling at least one of the first and second intensity adjustment units,
performs the span loss adjustment processing and the intensity difference adjustment processing as an initial setting operation after output of the second wavelength division multiplexed optical signal from the second light output unit starts, and
performs a monitoring operation of repeating the span loss adjustment processing and the intensity difference adjustment processing on a predetermined cycle after the initial setting operation ends.
